(19) United States
(12) Patent Application Publication
(10) Pub. No.: US 2011/0149338 A1
(43) Pub. Date: Jun. 23, 2011

(54) PARALLEL DECODE FOR RUN LENGTH LIMITED ENCODED DATASTREAMS

(76) Inventor: Michael J. Holley, Broomfield, CO (US)

(21) Appl. No.: 12/644,759

(22) Filed: Dec. 22, 2009

(51) Int. Cl. G06F 15/02; H04L 29/02

(52) U.S. Cl. 358/1.15; 370/464

(57) ABSTRACT

Methods and systems for parallel decoding Run Length Limited (RLL) encoded datastreams is disclosed. In one embodiment, a decoding system includes a parsing system, a first decoder, and a second decoder. The parsing system receives a Run Length Limited (RLL) encoded datastream and identifies a first header and a following header from the datastream. The first header defines a first number of subsequent data blocks and a first RLL encoding of the first number of data blocks. The following header defines a following number of subsequent data blocks and a following RLL encoding of the following number of data blocks. The first decoder is operable to decode the first number of data blocks based on the first encoding and the second decoder is operable to decode the following number of data blocks based on the following encoding in parallel with the first decoder to generate an output.

### BACKGROUND

1. Field of the Invention

The invention is related to the field of decoding systems and, in particular, to parallel decoding of Run Length Limited (RLL) encoded datastreams.

2. Statement of the Problem

Print data transmitted between various processes within a printing system is typically encoded to reduce the amount of bandwidth required to transmit the data. Before the encoded print data is finally printed, the print data is decoded. In some cases, however, the printing speed of the printing system is not limited by a print engine printing the data, but instead by the speed at which the printing system decodes the print data prior to printing the data.

One type of data encoding is RLL encoding. RLL encoding is a lossless compression scheme which bounds the length of runs of repeat data during which the signal does not change. If the runs are too long, then clock recovery becomes difficult. If the runs are too short, then the communication channel might attenuate the high frequencies within the signal.

Apple Computer, Inc. introduced a RLL encoding scheme with the release of the Macintosh® computer called PackBits. A PackBits datastream includes packets with a one-byte header followed by one or more bytes of data. The header is a signed byte. The header defines the following data as either literal data or repeat data. The header also defines the number of bytes of encoded literal data or encoded repeat data. In other words, the header encodes both the type of data (literal or repeat) and the amount of encoded data.

One problem with decoding RLL datastreams, such as PackBits, is that the decoding scheme inherently requires serial processing of each byte of the datastream to determine how to treat each subsequent byte of the datastream. The serial processing of each byte of the datastream can limit the performance of systems relying on the decoded output of a RLL datastream, such as printing systems.

### SUMMARY

Embodiments herein describe parallel decoding of RLL encoded datastreams. Sequential headers defining blocks of RLL encoded data are identified from the datastream. The blocks of RLL encoded data are parsed from the datastream and decoded in parallel to generate a decoded output. Decoding the datastream in parallel provides for an improvement in the decoding performance as compared to serial decoding the datastream.

One embodiment comprises a decoding system including a parsing system, a first decoder, and a second decoder. The parsing system is operable to receive a Run Length Limited (RLL) encoded datastream, to identify a first header from the datastream that defines a first number of data blocks subsequent to the first header and a first RLL encoding of the first number of data blocks. The parsing system is further operable to identify a following header with the datastream that defines a following number of data blocks subsequent to the following header and a following RLL encoding of the following data blocks. The first decoder is operable to decode the first number of data blocks based on the first RLL encoding, and the second decoder is operable to decode the following number of data blocks based on the following RLL encoding in parallel with the first decoder to generate an output.

Another embodiment comprises a method of parallel decoding of a Run Length Limited (RLL) encoded datastream. According to the method, the RLL datastream is received. A first header within the datastream is identified that defines a first number of data blocks subsequent to the first header and a first RLL encoding of the first number of data blocks. A following header within the data stream is identified that defines a following number of data blocks subsequent to the following header and a following RLL encoding of the following number of data blocks. The first number of data blocks are decoded in parallel with the following number of data blocks. The first number of data blocks are decoded based on the first RLL encoding. The second number of data blocks are decoded based on the following RLL encoding. The decoding of the first number of data blocks and the following number of data blocks generates a decoded output.

Other exemplary embodiments may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 illustrates a decoding system in an exemplary embodiment.

FIG. 2 illustrates a run length limited encoded datastream.

FIG. 3 is a flow chart illustrating a method of decoding a run length limited encoded datastream in an exemplary embodiment.

FIG. 4 illustrates a printer in an exemplary embodiment.

FIG. 5 is a flow chart illustrating a method of decoding a run length limited encoded datastream in an exemplary embodiment.

FIG. 6 illustrates an alternate decoding system in an exemplary embodiment.

### DESCRIPTION OF EMBODIMENTS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

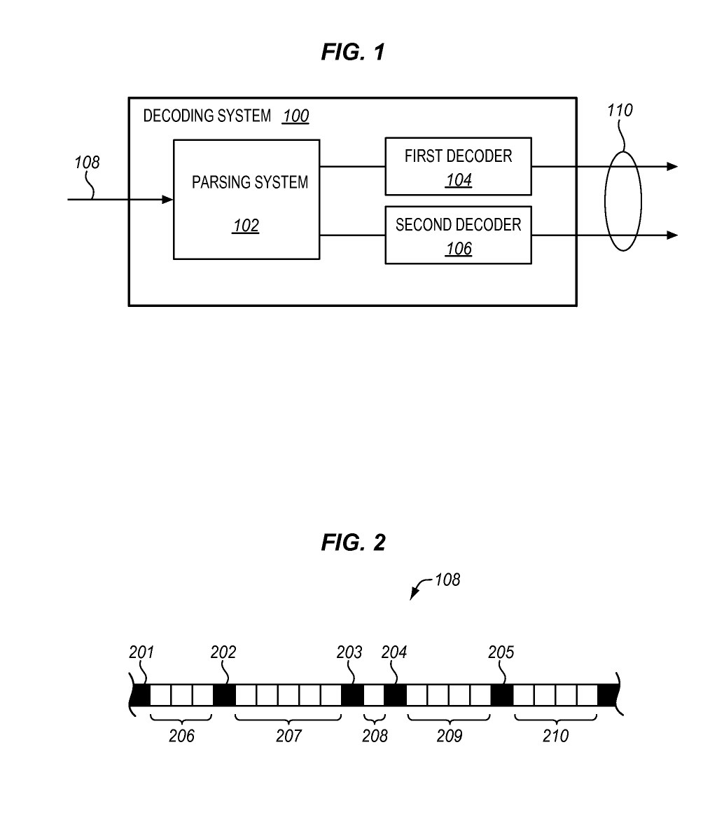

FIG. 1 illustrates a decoding system 100 in an exemplary embodiment. Decoding system 100 includes a parsing system 102, a first decoder 104, and a second decoder 106. Parsing system 102 comprises any device, component, or system operable to receive a RLL encoded datastream 108 and to identify headers within datastream 108. First decoder 104 comprises any device, component, or system operable to decode data defined by the headers. Second decoder 106 also comprises any device, component, or system operable to decode data defined by the headers. Decoding system 100 may, for example, be included within a printing system for decoding RLL encoded print data streams before printing the decoded output.

FIG. 2 illustrates a RLL encoded datastream 108. Datastream 108 includes headers 201-205 and data blocks 206-210, each of which may include one or more bits or bytes of header or data. In datastream 108, headers 201-205 define respective data blocks 206-210. For example, header 201 defines data block 206 and header 202 defines data block 207. In like manner, header 203 defines data block 208, header 204 defines data block 209, and header 205 defines data block 210. For example, headers 201-205 may define a type of RLL encoding or a number of encoded elements of respective data blocks 206-210. Although datastream 108 illustrates a specific configuration of headers 201-205 and data blocks 206-210, one skilled in the art will recognize that datastream 108 may comprise various combinations of headers and data blocks. Thus, datastream 108 is not limited to the specific configuration illustrated in FIG. 2.

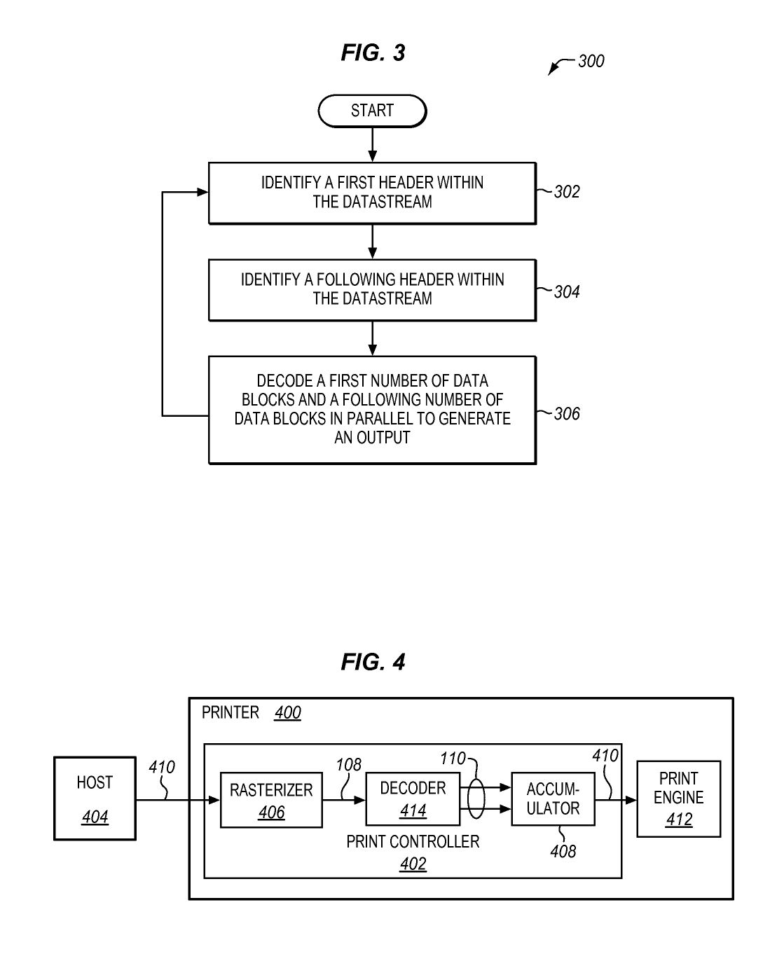

FIG. 3 is a flow chart illustrating a method 300 of decoding RLL encoded datastream 108 in an exemplary embodiment. The steps of method 300 will be described with reference to decoding system 100 of FIG. 1, although one skilled in the art will recognize that method 300 may be performed by other systems not shown. Also, the steps of the flow charts provided herein is not all inclusive and other steps, not shown, may be included. Further, the steps may be performed in an alternative order.

In step 302, parsing system 102 of encoding system 100 receives datastream 108. Datastream 108 may comprise any RLL encoded datastream, such as the RLL encoded datastream illustrated in FIG. 2. In step 302, first decoder 104 identifies a first header 202 (see FIG. 2) within a datastream 108. In FIG. 1, datastream 108 comprises any RLL encoded datastream, such as the RLL encoded datastream illustrated in FIG. 2. First header 202 defines a first number of data blocks 207 that are subsequent to first header 202 in datastream 108. First header 202 also defines a first RLL encoding for the first number of data blocks 207.

In step 304, parsing system 102 identifies a following header 203 within datastream 108. Following header 203 defines a following number of data blocks 208 that are subsequent to following header 203 in datastream 108. Following header 203 also defines a following RLL encoding for the following number of data blocks 208.

In step 306, first decoder 104 and second decoder 106 decode their respective portions of datastream 108 in parallel to generate an output. First decoder 104 decodes the first number of data blocks 207 based on the first RLL encoding. Second decoder 106 decodes the following number of data blocks 208 based on the following RLL encoding in parallel with first decoder 104 to generate an output 110. By identifying and decoding data blocks 207 and 208 in parallel, decoding system 100 provides for an improved decode performance of datastream 108 as compared to decoding datastream 108 in a serial manner. After generating an output 110, additional downstream headers may be identified within datastream 108 and blocks of data decoded until print datastream 108 is decoded in its entirety. As datastream 108 is processed in this manner, steps 302-306 may be repeated as illustrated in FIG. 2

In some cases, print data is encoded in an RLL format for transmission between print controller processes to reduce the amount of bandwidth and/or the memory storage usage of the print data. For example, a host may generate a Page Description Language (PDL) print datastream for a printer. After the printer receives the PDL print datastream, the printer may rasterize the PDL datastream and generate an RLL encoded datastream for subsequent processing and transmission to a print engine for output. In addition, while FIGS. 1 and 2 illustrate two decoders in parallel, one skilled in the art will recognize that decoding system 100 may include a plurality of decoders in parallel operable to decode two, three, four, or an additional number of data blocks in parallel to generate a decoded output.

FIG. 4 illustrates a printer 400 in an exemplary embodiment. Printer 400 comprises any system used to provide marks on a media, such as a continuous forms printer or a cut sheet page printer. Printer 400 may be owned by a company or other entity, and may be shared by multiple users. In this embodiment, Printer 400 includes a print controller 402. Print controller 402 comprises any system, server, or components operable to interface a host system 404 with one or more print engines 412, and to control the printing of print jobs received from host systems 404 for the print engines 412. Print controller 402 may include one or more rasterizers 406 operable to receive PDL print data 410 from host system 404, such as PostScript data, PDF (Portable Document Format) data, Intelligent Printer Data Stream (IPDS) data, Advanced Function Presentation (AFP) data, Mixed Object: Document Content Architecture (MODCA), or other types of PDL data and generate RLL encoded datastream 108. Print controller 402 may also include one or more accumulators 410 operable to receive decoded output 110, and generate decoded datastream 410 for print engine 412. Accumulator 408 may, for example, combine the parallel-decoded output streams generated by decoder 414 to maintain the correct temporally sequential relationship between data within datastream 108 and data within datastream 410. Print engine 412 comprises any system operable to provide an imaging process to mark a printable medium, such as paper. Printer 400 may include other components or systems not shown for the sake of brevity.

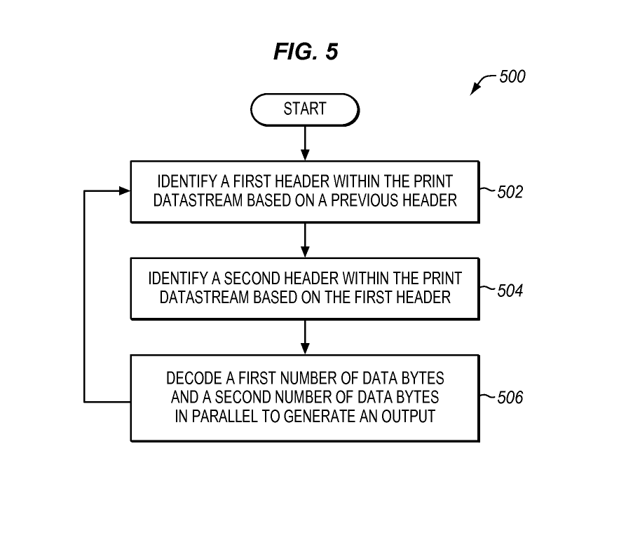

FIG. 5 is a flow chart illustrating a method 500 in an exemplary embodiment. The steps of method 500 will be described with reference to printer 400 of FIG. 4, although one skilled in the art will recognize that method 500 may be performed by other systems not shown.

In step 502, print controller 402 identifies first header 202 within datastream 108 based on previous header 201. For example, rasterizer 406 may receive PDL print data 410 from host system 404, and convert PDL print data 410 into datastream 108. If datastream 108 is a PackBits datastream, then print controller 402 may first identify previous header 201 as defining literal data. In a PackBits datastream, headers may comprise literal headers, repeat headers, or indicate a skip header.

The following table illustrates how headers are encoded in PackBits:

TABLE 1

| Header | Data following the header |
|---|---|
| 0 to 127 | (1 + n) literal bytes of data |
| −1 to −127 | One byte of data repeated (1 − n) times in |
| | the decompressed output |
| −128 | No operation (skip and treat the next byte |
| | as a header byte) |

When the signed header ranges from 0 to 127, the header defines the bytes subsequent to the header in the datastream as literal data. The value of the header also defines the number of bytes of literal data as 1+n, where n is the signed value of the header. For example, if previous header 201 has a value of 2, then previous header 201 defines that the next 3 bytes in datastream 108 are literal data bytes. This is indicated by data block 206 in FIG. 2, which spans 3 blocks of data.

After print controller 402 identifies previous header 201, print controller 402 may then generate an offset within datastream 108 to locate first header 202 based on previous header 201. In the example, previous header 201 defines 3 bytes of literal encoded data (e.g., previous header 201 has a value of 2 such that previous header 201 defines 2+1 bytes of subsequent literal data in datastream 108). Thus, print controller 402 may calculate a 4 byte offset (i.e., 1 header byte plus 3 data bytes) from previous header 201 to locate first header 202. After locating first header 202 in datastream 108, print controller 402 may then identify, for example, that first header 202 has a value of 4. Because first header 202 resides within the range from 0 to 127, first header 202 also defines 5 bytes (i.e., 4+1) of literal data in datastream 108. This is indicated by data block 207.

In step 504, print controller 402 identifies a second header 203 within datastream 108 based on first header 202. In continuing with the example, first header 202 defines 5 bytes of literal encoded data. Print controller 402 may then identify second header 203 within datastream 108 based on a 6 byte offset (1 header byte plus 5 data bytes) from first header 202. After locating second header 203 in datastream 108, print controller 402 may then identify second header 203 as defining repeat encoded data.

Referring again to table 1 above, when the header value resides within a range of −1 to −127, the header defines one byte of data repeated 1-n times in the decoded output. For example, if a header has a value of −5, then the header defines that the following byte is repeated 6 times in the decoded output. Because the data byte is repeated, only one byte of data is used to represent the decoded output.

In step 506, print controller 402 decodes the first number of data bytes defined by first header 202 in step 502 (i.e., data block 207) in parallel with the second number of data bytes defined by second header 203 in step 504 (i.e., data block 207) to generate output 110. As subsequent processing remains for datastream 108 for decoding, processing returns to step 502. Steps 502-506 will be described with reference to headers 204-205 and data blocks 209-210 in FIG. 2.

Returning to step 502, print controller 402 identifies header 204 based on header 203 (previously as second header 203). In the example, header 203 defines repeat encoded data. Thus, header 203 defines one byte of data, repeated (1-n) times in the decoded output. Print controller 402 may then identify header 204 based on a 2 byte offset (1 header byte plus 1 repeat byte). After locating header 204, print controller 402 may then identify header 204, for example, as defining 4 bytes of literal encoded data as indicated in data block 209.

In step 504, print controller 402 identifies a header 205 based on header 204. In the example, header 204 defines 4 bytes of literal encoded data. Print controller 402 may then identify header 205 based on a 5 byte offset. After locating header 205, print controller 402 may then identify header 205 as defining 4 bytes of literal data (e.g., header 205 has a value of 4) as indicated in block 210.

In step 506, print controller 402 decodes the number of data bytes defined by header 204 in step 502 (i.e., data block 209) in parallel with the number of data bytes defined by header 205 in step 504 (i.e., data block 210) to generate output 110. Processing datastream 108 continues repeatedly between steps 502-506 until datastream 108 is decoded in its entirety. After print controller 402 generates output 110, accumulator 408 combines output 110 into datastream 410 for print engine 412 to generate a printed output.

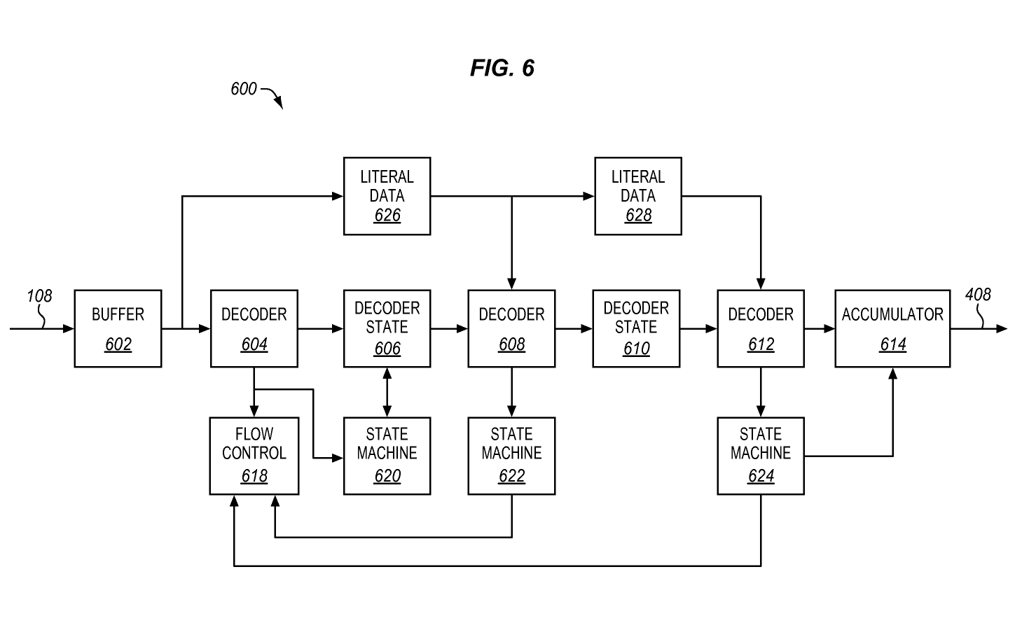

FIG. 6 illustrates a decoding system 600 in another exemplary embodiment. Decoding system 600 is embodied as programmable logic on a programmable logic device, although one skilled in the art will recognize that decoding system 600 may have alternate embodiments. For example, decoding system 600 may be implemented within printer 400 of FIG. 4.

In FIG. 6, decoding system 600 is operable to decode a PackBits encoded datastream 108 in parallel to generate decoded output 110. In this embodiment, decoding system 600 is operable to decode up to two headers at a time, process up to eight input bytes per cycle, and generate up to 16 output bytes per cycle. In decoding system 600, the PackBits algorithm is parsed into finite computational elements and coded into three main stages, including two sub-stages for each main stage.

Decoder 604 receives eight bytes of data comprising datastream 108 from buffer 602, decodes the first byte of datastream 108 (in our example, we will consider first header 202 (see FIG. 2) as the first byte of datastream 108 for continuity of example) into ignore, repeat, or literal data, and computes the number of literal or repeats to identify second header 203. This process is repeated to identify header 204 if header 204 is within the current eight bytes of data. If the location of header 204 is also within the eight bytes of data, then decoder 604 stalls to allow for subsequent decode processing within the eight bytes of data. If the location of header 204 is not within the eight bytes of data, then decoder 604 receives an additional eight bytes of data from buffer 602 to continue processing.

Flow control 618 is a flow control state machine across all decoding stages, collecting stall signals from the decoding stages to halt reads at the system input. Pointer 620 contains information about the current decode location within datastream 108. Literal data 626 and literal data 628 transmit literal data decoded from decoder 604 to decoder 608 and decoder 612. Decode state 606 and 610 track current pointers and counters for each corresponding stages' progress in decoding data streams.

Decoder 608 receives up to two valid header decodes from decoder 604. Decoder 608 implements the repeat byte command by multiplying one to eight bytes of data output. Decoder 608 implements the literal output by accepting from one to eight bytes at a time from decoder 604 and passing the literal output on to decoder 612. Decoder 608 may receive ignore/skip headers from decoder 604, but decoder 608 ignores the ignore/skip headers. Decoder 608 recognizes valid data from decoder 604 by decoding a passed-on header from decoder 604. Decoder 608 will stall using state machine 622 if decoder 604 is implementing a repeat output over multiple cycles.

Decoder 612 accepts valid repeat and literal data from decoder 608. Decoder 612 can process up to two full eight-byte words from decoder 608. Decoder 612 may also be stalled by state machine 624 when buffer 614 is full. State machine 624 may also stall decoder 608 and decoder 604 when this occurs. Accumulator 614 recombines the parallelized multiple decoded data streams while maintaining the original order of the incoming data from decoder 612. It is designed to be twice as wide as the preceding data path to accommodate dual streams of data without causing a stall in the decode stages. Its ability to output 16 bytes at a time allows the overall throughput to stay very high even if a decode stalls occasionally due to poor compression.

Any of the various elements shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Although specific embodiments were described herein, the scope of the invention is not limited to those specific embodiments. The scope of the invention is defined by the following claims and any equivalents thereof.

I claim:

1. A method comprising:
identifying a first header within a Run Length Limited (RLL) encoded datastream that defines a first number of data blocks subsequent to the first header and a first RLL encoding of the first number of data blocks;
identifying a following header within the datastream that defines a following number of data blocks subsequent to the following header and a following RLL encoding of the following number of data blocks; and
decoding the first number of data blocks based on the first RLL encoding and the following number of data blocks based on the following RLL encoding in parallel to generate an output.

2. The method of claim 1 wherein:
identifying the first header further comprises:
identifying the first header based on a previous header and a previous number of data blocks preceding the first header in the datastream, and
identifying the following header further comprises:
identifying the following header based on the first header and the first number of data blocks subsequent to the first header.

3. The method of claim 1 further comprising:
repetitively performing the steps of identifying the first header, identifying the following header, and decoding to generate the output.

4. The method of claim 1 further comprising:
printing the decoded output on a printer.

5. A decoding system comprising:
a parsing system operable to identify a first header from a Run Length Limited (RLL) encoded datastream that defines a first number of data blocks subsequent to the first header and a first RLL encoding of the first number of data blocks, and to identify a following header within the datastream that defines a following number of data blocks subsequent to the following header and a following RLL encoding of the following number of data blocks;
a first decoder operable to decode the first number of data blocks based on the first RLL encoding; and
a second decoder operable decode the following number of data blocks based on the following RLL encoding, wherein the first decoder and the second decoder operate in parallel to generate an output.

6. The decoding system of claim 5 wherein the first parsing system is further operable to identify the first header based on a previous header and previous number of data blocks subsequent to the previous header, and to identify the following header based on the first header and first number of data blocks subsequent to the first header.

7. The decoding system of claim 6 wherein the parsing system is further operable to repetitively identify a first header within the datastream and a second header within the datastream to generate the output.

8. The decoding system of claim 6 wherein:
the first decoder and the second decoder are further operable to transmit the decoded output to a print engine for printing.

9. A method comprising:
identifying a first header within a byte oriented Run Length Limited (RLL) encoded print datastream that defines a first number of data bytes subsequent to the first header and a first RLL encoding of the first number of data bytes;
identifying a second header within the print datastream that defines a second number of data bytes subsequent to the second header and a second RLL encoding of the second number of data blocks; and
decoding the first number of data bytes based on the first RLL encoding and the second number of data bytes based on the second RLL encoding in parallel to generate an output.

10. The method of claim 9 wherein:
identifying the first header further comprises:
identifying the first header based on a previous header and previous number of data bytes subsequent to the first header, and
identifying the second header further comprises:
identifying the second header based on the first header and first number of data bytes subsequent to the first header.

11. The method of claim 9 further comprising:
printing the decoded output on a printer.

12. The method of claim 9 further comprising:
identifying a third header within the print datastream that defines a third number of data bytes subsequent to the third header and a third RLL encoding of the third number of data bytes; and
identifying a fourth header within the print datastream that defines a fourth number of data bytes subsequent to the fourth header and a fourth RLL encoding of the fourth number of data blocks.

13. The method of claim 12 wherein:
identifying the third header further comprises:
identifying the third header based on the second header and the second number of data bytes subsequent to the second header, and
identifying the fourth header further comprises:
identifying the fourth header based on the third header and the third number of data bytes subsequent to the third header.

14. A printer comprising:
a print controller operable to identify a first header within a byte oriented Run Length Limited (RLL) encoded print datastream that defines a first number of data bytes subsequent to the first header and a first RLL encoding of the first number of data bytes, to identify a second header within the print datastream that defines a second number of data bytes subsequent to the second header and a second RLL encoding of the second number of data blocks, and to decode the first number of data bytes based on the first RLL encoding and the second number of data bytes based on the second RLL encoding in parallel to generate an output.

15. The printer of claim 14 wherein the print controller is further operable to identify the first header based on a previous header and previous number of data bytes subsequent to the first header, and to identify the second header based on the first header and first number of data bytes subsequent to the first header.

16. The printer of claim 14 further comprising:
a print engine operable to print the decoded output.

17. The printer of claim 14 wherein the print controller is further operable to identify a third header within the print datastream that defines a third number of data bytes subsequent to the third header and a third RLL encoding of the third number of data bytes, and to identify a fourth header within the print datastream that defines a fourth number of data bytes subsequent to the fourth header and a fourth RLL encoding of the fourth number of data bytes.

18. The printer of claim 17 wherein the print controller is further operable to identify the third header based on the second header and the second number of data bytes subsequent to the second header, and to identify the fourth header based on the third header and the third number of data bytes subsequent to the third header.
